(19) United States
(12) Patent Application Publication
(10) Pub. No.: US 2024/0020487 A1
(43) Pub. Date: Jan. 18, 2024

(54) COMPUTER-READABLE RECORDING MEDIUM STORING MACHINE LEARNING PROGRAM, MACHINE LEARNING METHOD, AND INFORMATION PROCESSING APPARATUS

(71) Applicant: Fujitsu Limited, Kawasaki-shi (JP)

(72) Inventor: yuji MIZOBUCHI, Kawasaki (JP)

(73) Assignee: Fujitsu Limited, Kawasaki-shi (JP)

(21) Appl. No.: 18/348,759

(22) Filed: Jul. 7, 2023

(30) Foreign Application Priority Data
Jul. 14, 2022 (JP) 2022-113423

(51) Int. Cl. G06F 40/40

(52) U.S. Cl. CPC G06F 40/40

(57) ABSTRACT

A non-transitory computer-readable recording medium stores a machine learning program for causing a computer to execute processing including: measuring, for each data, a non-functional performance that represents a performance for a requirement that excludes a function of each data; and by machine learning that uses divided data obtained by dividing each data into a first portion of the data and a second portion that is correct answer data as training data, executing machine learning processing of training a prediction model that predicts the second portion of the data in response to an input of the first portion of the data, wherein the machine learning processing uses a loss function that includes a parameter determined according to a measurement result of the non-functional performance that is the parameter that indicates a ratio of reflecting the non-functional performance in the prediction model.

### CROSS-REFERENCE TO RELATED APPLICATION

This application is based upon and claims the benefit of priority of the prior Japanese Patent Application No. 2022-113423, filed on Jul. 14, 2022, the entire contents of which are incorporated herein by reference.

### FIELD

The embodiments discussed herein are related to a machine learning program, a machine learning method, and an information processing apparatus.

### BACKGROUND

As a technique for assisting program generation, document generation, or the like, a language model is known. For example, a language model that automatically generates documents uses a sequence of sentences up to the middle as an input, using a corpus that is a large amount of language resources and is trained to correctly predict a document following the input. A language model that automatically generates programs uses a prompt of a program as an input, using the corpus that is a large amount of language resources and is trained to correctly predict a subsequent code following the prompt.

Greg Brockman, Mira Murati, Peter Welinder & OpenAI, [online], retrieved on Feb. 4, 2020, “OpenAI API”, “https://openai.com/blog/openai-api/” is disclosed as related art.

### SUMMARY

According to an aspect of the embodiments, a non-transitory computer-readable recording medium stores a machine learning program for causing a computer to execute processing including: measuring, for each of a plurality of pieces of data, a non-functional performance that represents a performance for a requirement that excludes a function of each of the plurality of pieces of data; and by machine learning that uses divided data obtained by dividing each of the plurality of pieces of data into a first portion of the data and a second portion that is correct answer data as training data, executing machine learning processing of training a prediction model that predicts the second portion of the data in response to an input of the first portion of the data, wherein the machine learning processing uses a loss function that includes a parameter determined according to a measurement result of the non-functional performance that is the parameter that indicates a ratio of reflecting the non-functional performance in the prediction model.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining a language model of an information processing apparatus according to a first embodiment;

FIG. 2 is a diagram for explaining training of the language model;

FIGS. 3A and 3B are a diagram for explaining a reference technique;

FIG. 4 is a diagram for explaining a loss function used for training by the reference technique;

FIG. 5 is a diagram for explaining code generation using a language model of the reference technique;

FIG. 6 is a diagram for explaining problems of training of the language model of the reference technique;

FIG. 7 is a diagram for explaining training of the language model according to the first embodiment;

FIG. 8 is a functional block diagram illustrating a functional configuration of the information processing apparatus according to the first embodiment;

FIG. 9 is a diagram for explaining measurement of a non-functional performance;

FIG. 10 is a diagram for explaining generation of training data;

FIG. 11 is a diagram for explaining machine learning of the language model;

FIG. 12 is a flowchart illustrating a flow of processing according to the first embodiment; and

FIG. 13 is a diagram illustrating a hardware configuration example.

### DESCRIPTION OF EMBODIMENTS

For training of such a language model, a classification task for predicting one code or word from all codes or words is solved each time when each code or each word is generated, a difference between a correct answer and prediction is calculated as a cross entropy, and a loss function for minimizing the cross entropy is used.

By the way, a program or a document that is a prediction target of a language model has a functional performance and a non-functional performance that respectively represent performances for a functional requirement and a non-functional requirement. For example, in a case of the program, the functional requirement is a requirement in which an operation and a behavior of the program are defined, and the non-functional requirement is a requirement excluding the functional requirement required for the program and is a program execution speed, accuracy of a machine learning model generated by the program, or the like.

In training of the language model described above, in order to generate a prediction result that achieves a desired non-functional performance, generation of the prediction result and training of the language model are repeated, and a time period required for the generation increases. For example, the language model described above is generated through training based on a statistical approach that is training based on a superficial appearance probability in a corpus. Therefore, in a case where a language model depending on a status of the non-functional performance of each piece of the training data in the corpus is generated and prediction is performed using the language model, the prediction result that satisfies the desired non-functional performance may be immediately generated or not generated at all, and the entire process takes a long time period.

In one aspect, an object is to provide a machine learning program, a machine learning method, and an information processing apparatus that can generate a prediction result that satisfies a required non-functional performance in a short period of time.

Hereinafter, embodiments of a machine learning program, a machine learning method, and an information processing apparatus disclosed in the present application will be described in detail with reference to the drawings. Note that the present disclosure is not limited by the embodiments. Furthermore, the embodiments may be appropriately combined with each other in a range without contradiction.

### First Embodiment

(Description of Information Processing Apparatus)

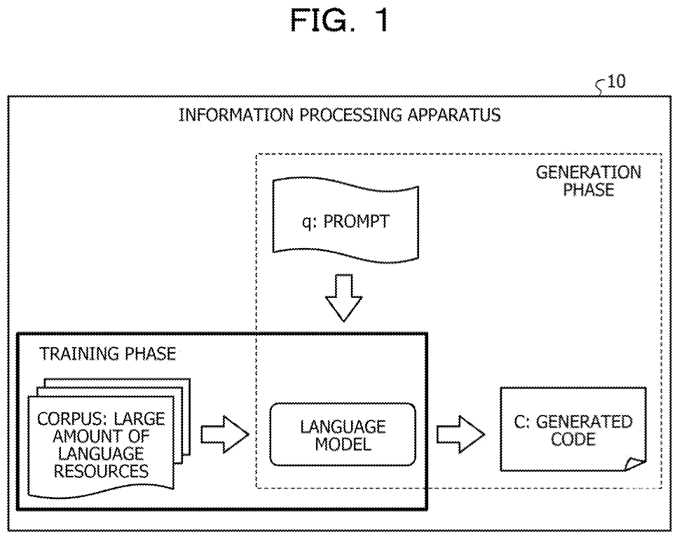

FIG. 1 is a diagram for explaining a language model of an information processing apparatus 10 according to a first embodiment. The information processing apparatus 10 illustrated in FIG. 1 is an example of a computer that generates a language model that is an example of a prediction model for assisting program generation, document generation, or the like.

For example, when the program generation is described as an example, in a training phase, the information processing apparatus 10 generates the language model using a corpus including a large amount of language resources. In a generation phase, the information processing apparatus 10 inputs, for example, a prompt q that is an example of a seed for random number generation and indicates a departure point of code generation into a machine learned language model and generates a code c following the prompt q. As a result, the information processing apparatus 10 can generate a code (script) of a program in which the prompt q and the code c are linked.

The language model is a model that gives a probability P(x) for a discrete symbol x (sequence x=x₁x₂x₃ . . . ) in a corpus D, for example. The reference x indicates a word, a sentence, a phoneme, or the like. P(x) indicates a probability that a language model M machine learned by the corpus D predicts and generates a sentence (or document) in a case where x is a word. For example, the prediction of the language model is to obtain a probability that the language model M trained according to the corpus D generates the sequence x, and original properties of a language are acquired by restrictions applied to the language model M or devisal through a training process.

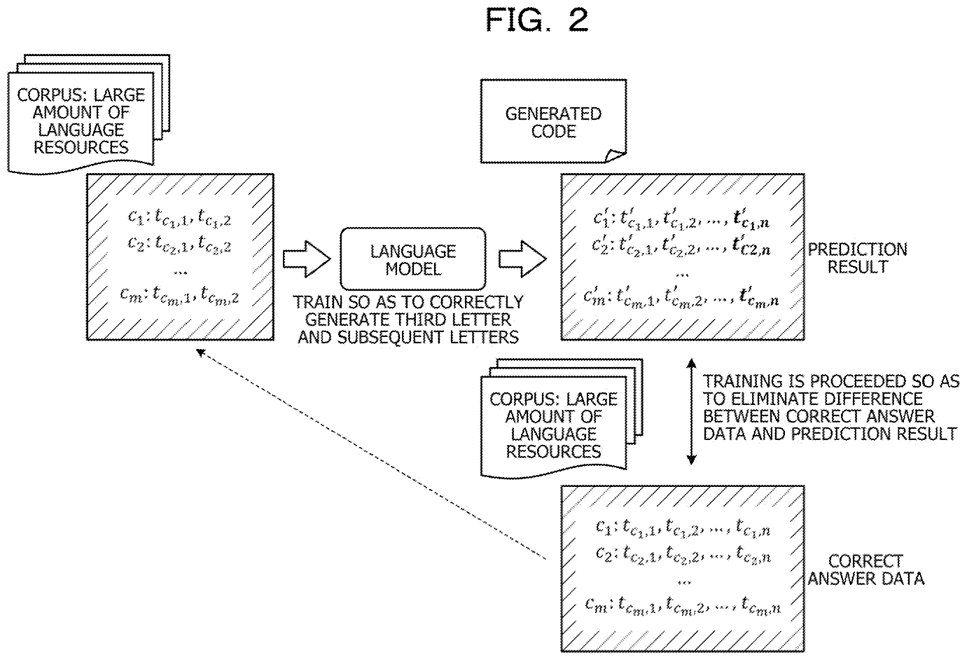

Next, training of the language model will be described. FIG. 2 is a diagram for explaining training of the language model. As illustrated in FIG. 2, the information processing apparatus 10 inputs a part of a document up to the middle in the corpus into the language model and acquires a generation result (prediction result) of a subsequent sentence (or word) of the input document from the language model. Then, the information processing apparatus 10 updates various parameters of the language model so as to reduce a difference between correct answer data and the prediction result. Note that, as the language model, various algorithms such as a neural network can be adopted.

For example, in the example in FIG. 2, the information processing apparatus 10 inputs data c₁ (c₁=t_{c1,1}, t_{c1,2}) including sequences t_{c1,1} and t_{c1,2} that are examples of codes, words, or the like into the language model, and acquires data c₁′(c₁′=t′_{c1,1}, t′_{c1,2}, . . . , t′_{c1,n}) including a subsequent sequence of the final sequence t_{c1,2} of the input data, as a prediction result of the language model. Then, the information processing apparatus 10 updates various parameters of the language model, so as to reduce a difference between correct answer data c₁ (c₁=t_{c1,1}, t_{c1,2}, . . . , t_{c1,n}) and a prediction result c₁′ (c₁′=t′_{c1,1}, t′_{c1,2}, . . . , t′_{c1,n}).

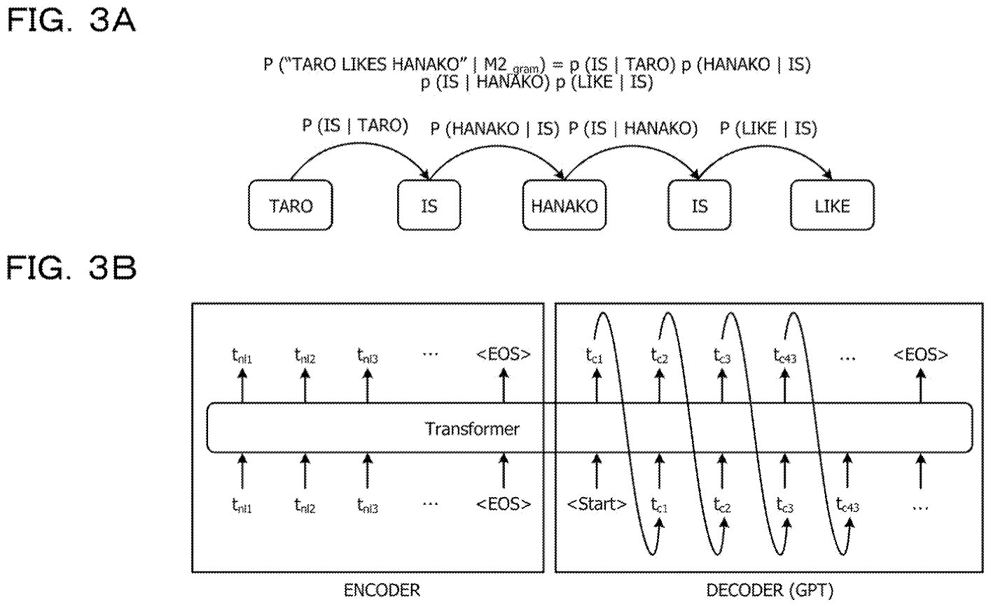

Here, as a reference technique of the language model that is typically used, n-gram and generative pre-training (GPT) are known. FIGS. 3A and 3B are a diagram for explaining the reference technique. The n-Gram illustrated in FIG. 3A is a model that expresses a word following immediately previous n−1 words as a conditional probability. For example, the n-Gram calculates a probability P (x|w₁, w₂, . . . , wᵢ) that a word x appears after a word sequence w₁, w₂, . . . , wᵢ is given, using the immediately previous n−1 words as a condition. For example, a case of 2 gram, it is expressed as P (“Taro likes Hanako”|M_{2_gram})=p (is|Taro) p (Hanako|is) p (is|Hanako) p (like|is). Machine learning of M_{n_gram} only calculates a conditional probability for each token (word) in the corpus. Usually, the number of words is very large, and when n exceeds five, most combinations are unknown combinations.

The GPT illustrated in FIG. 3B is an architecture in which decoders of Transformer are layered in multiple stages, and is a model for a generation model having autoregressive properties that is modeled by a word appearance probability. Note that the Transformer is a network architecture in which an encoder and a decoder are combined with an Attention model. The GPT performs machine learning with autoregression by repeating to input output data output by the encoder in response to an input of input data into a first decoder and to input output data of the first decoder into a second decoder.

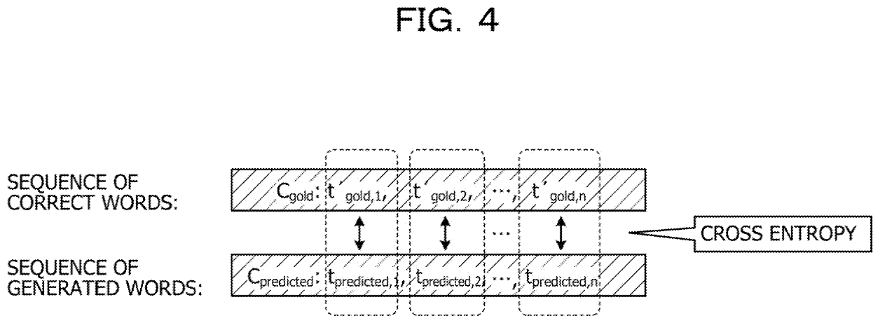

As a loss function of the machine learning of such a reference technique, a cross entropy is used. FIG. 4 is a diagram for explaining the loss function used for training by the reference technique. As illustrated in FIG. 4, in the reference technique, for each sequence of generated (predicted) words, a difference from a sequence of a correct words is calculated using the loss function indicated by the formula (1), and machine learning is performed so as to minimize each difference. In the example in FIG. 4, a difference between a sequence 1 “t′_{gold,1}” of correct answer data c_{gold} and a sequence 1 “t_{predicted,1}” of generated data c_{predicted} and a difference between a sequence 2 “t′_{gold,2}” of the correct answer data c_{gold} and a sequence 2 “t_{predicted,2}” of the generated data c_{predicted} are calculated according to the formula (1). Then, a language model is generated by machine learning that minimizes a sum of the difference between the sequences 1 and the difference between the sequences 2.

[Expression 1]

loss_{diff}=−Σᵢ₌₀^{i=|terms|}t′_{gold,i}*log(probₜ_{_{predicted,i}}) (|terms|: Number of all words) (1)

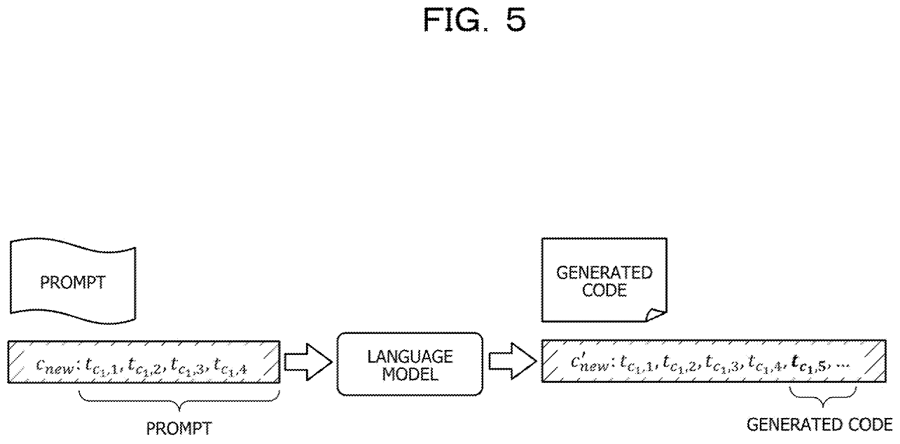

Thereafter, with the reference technique, a starting point or a departure point of the prompt or the like is given to the language model calculated through the processing described above, and automatic generation such as the program generation or the document generation is performed. FIG. 5 is a diagram for explaining code generation using the language model of the reference technique. As illustrated in FIG. 5, in the reference technique, document data to be predicted c_{new} (t_{c,1}, t_{c,2}, t_{c,3}, t_{c,4}) is input into the language model, and generated data c′_{new} (t′_{c,1}, t′_{c,2}, t′_{c,3}, t′_{c,4}, t′_{c,5}, . . . ) that is a generated sequence subsequent to a sequence (t_{c,4}) is acquired.

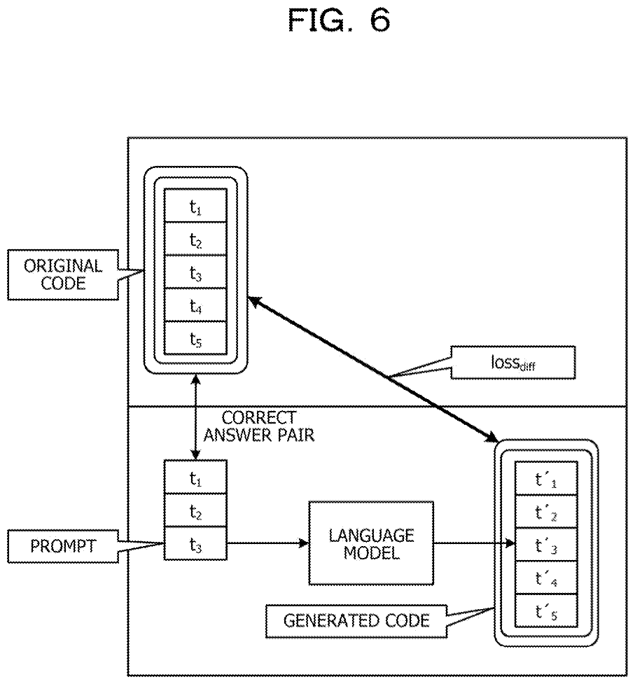

However, since the language model according to the reference technique performs automatic generation based on a statistical approach based on an appearance probability (frequency, co-occurrence, or the like) of a superficial character in the corpus, the language model cannot perform automatic generation in consideration of the non-functional performance of the code. FIG. 6 is a diagram for explaining problems of training of the language model of the reference technique.

As illustrated in FIG. 6, in the reference technique, a prompt “t₁, t₂, t₃” is generated from an original code “t₁, t₂, t₃, t₄, t₅” that is an example of a program code, and training data using the prompt as an explanatory variable and the original code as an objective variable is generated. Then, in the reference technique, the prompt is input into the language model, and the generated code (program code) is acquired. Then, a difference between the generated code and the original code is calculated according to a loss function loss_{deiff} of the formula (1), and the language model is trained so as to reduce the difference.

In this way, in the reference technique, even if the program is a program of which an execution speed of the original code that is the input data is slow or a program for generating a machine learning model with low prediction accuracy, these pieces of input data are not considered in the training of the language model. This is because the language model of the reference technique is a model mainly for general sentences and the general sentences do not have the non-functional performance requirements unlike the programs. For example, in the reference technique, a non-functional aspect in the corpus is not considered, and training for uniformly imposing penalties is performed. Therefore, whether or not the non-functional performance such as generation of a program with a high execution speed or generation of a program with high prediction accuracy is achieved is not considered in the program generation. If a program that achieves the required non-functional performance is not generated, generation of a prediction result and training of a language model may be repeated. Such repetition of the generation of the prediction result and the training of the language model, an entire time period required for generating the program that achieves the required non-functional performance is prolonged.

Therefore, the information processing apparatus 10 according to the first embodiment adds a term according to accuracy evaluation to a loss function at the time of machine learning of a language model so as to generate a highly non-functional program that can be executed.

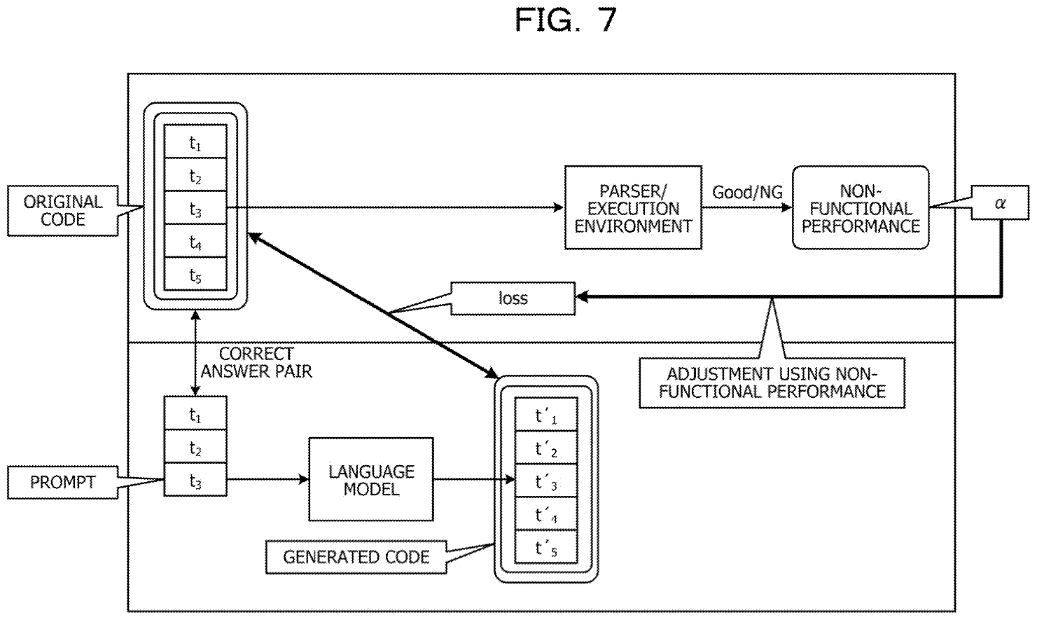

FIG. 7 is a diagram for explaining the training of the language model according to the first embodiment. The information processing apparatus 10 generates the prompt “t₁, t₂, t₃” from the original code “t₁, t₂, t₃, t₄, t₅” and generates training data using the prompt as an explanatory variable and the original code as an objective variable. Here, the information processing apparatus 10 executes the original code using an execution environment, measures a non-functional performance, and determines a ratio “a” of reflecting the non-performance function in the language model using the measured result.

Then, the information processing apparatus 10 inputs the prompt into the language model, acquires a generated code, calculates a difference between the generated code and the original code according to the loss function loss including a parameter indicating the ratio described above, and trains the language model so as to reduce the difference.

In this way, by performing machine learning in consideration of the non-functional performance that is characteristics required for the program, the information processing apparatus 10 can generate the prediction result that satisfies the required non-functional performance in a short time, without repeating the generation of the prediction result and the training of the language model.

(Functional Configuration)

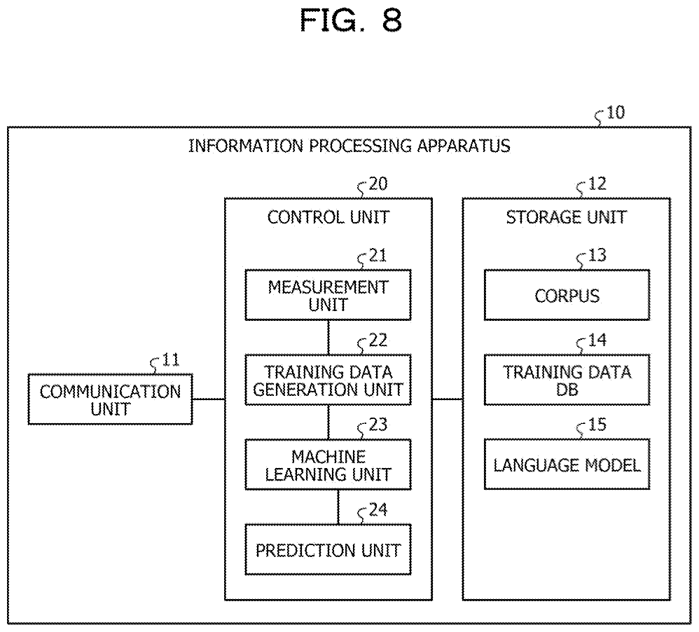

FIG. 8 is a functional block diagram illustrating a functional configuration of the information processing apparatus 10 according to the first embodiment. As illustrated in FIG. 8, the information processing apparatus 10 includes a communication unit 11, a storage unit 12, and a control unit 20.

The communication unit 11 is a processing unit that controls communication with another device and is implemented by, for example, a communication interface or the like. For example, the communication unit 11 receives various instructions from an administrator's terminal or the like and transmits a training result to the administrator's terminal.

The storage unit 12 is a processing unit that stores various types of data, programs to be executed by the control unit 20, or the like and is implemented by, for example, a memory, a hard disk, or the like. The storage unit 12 stores a corpus 13, a training data database (DB) 14, and a language model 15.

The corpus 13 is a database that stores a large amount of various types of data used to train the language model. For example, the corpus 13 stores a plurality of programs that is programs (code of program) each including a prompt and a code following the prompt. In the example described above, the corpus 13 stores a large amount of original codes.

The training data DB 14 is a database that stores the training data of the language model. For example, the training data DB 14 stores a plurality of pieces of training data that is divided data obtained by dividing each of a plurality of pieces of data into a first portion of the data and a second portion that is correct answer data. For example, each piece of the training data is supervised data in which the prompt and correct answer information (correct answer code) are associated. Note that the training data stored here may be generated using the data stored in the corpus 13 or may be generated using another piece of data.

The language model 15 is an example of a prediction model that predicts a subsequent portion of the input data and outputs the predicted portion. For example, the language model 15 generates the code following the prompt, in response to the input of the prompt of the program and outputs a code of the program in which the prompt and the code are coupled. In another example, the language model 15 generates a document after the middle of the document in response to an input of the document up to the middle and outputs sentence data.

The control unit 20 is a processing unit that performs overall control of the information processing apparatus 10 and, for example, is implemented by a processor or the like. The control unit 20 includes a measurement unit 21, a training data generation unit 22, a machine learning unit 23, and a prediction unit 24. Note that the measurement unit 21, the training data generation unit 22, the machine learning unit 23, and the prediction unit 24 are implemented by an electronic circuit included in a processor or a process executed by the processor.

The measurement unit 21 is a processing unit that measures a non-functional performance representing a performance for requirements excluding a function of each of the plurality of pieces of data, for each of the plurality of pieces of data stored in the corpus 13. The measurement unit 21 stores a measurement result in the storage unit 12 and outputs the measurement result to the training data generation unit 22. In a case where each piece of data is a program, information for defining an operation or a behavior of the program is the functional performance, and requirements excluding a functional requirement required for the program are the non-functional requirements.

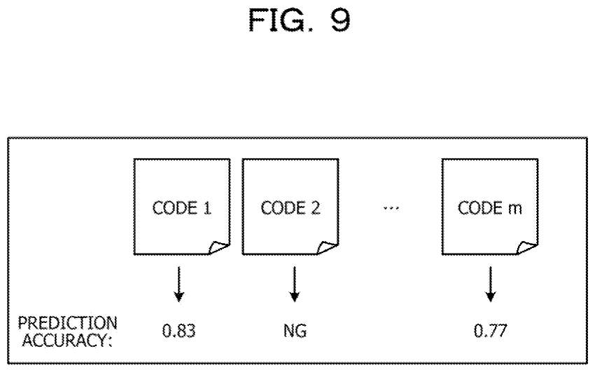

For example, an example will be described where each of the plurality of pieces of data stored in the corpus 13 is a script that generates a prediction model in the machine learning. FIG. 9 is a diagram for explaining measurement of the non-functional performance. As illustrated in FIG. 9, the measurement unit 21 performs prediction using a prediction model generated by executing a code 1 and calculates prediction accuracy “0.83” at that time. The measurement unit 21 performs prediction using a prediction model generated by executing a code 2 and calculates “NG” because the prediction accuracy at that time is less than a threshold. The measurement unit 21 performs prediction using a prediction model generated by executing a code 3 and calculates prediction accuracy “0.77” at that time. Note that, as the prediction accuracy, an average value of each prediction using each piece of data or the like can be adopted.

Note that, in a case of the program, a memory usage amount when the program is executed, a program execution speed, or the like can be used, instead of the prediction accuracy. In a case of the program execution speed, a function for converting values from zero to infinity into a value from one to zero. For example, the measurement unit 21 converts an execution speed x using a function such as “x/(x+1)”, “x²/(x²+1)” or “arctan (x)×(2/n)”.

However, the language model targeted in the first embodiment is not limited to the model that generates programs. For example, a model that generates essays or answers in Japanese can be targeted. In this case, in a situation where a large number of answers of students are collected such as examinations held by a XX tutoring school or university entrance examinations, when a model for generating a sentence using an answer example is created, a model is generated so that an answer example with a higher score is more strongly reflected in the model. The functional performance in this case is a function that defines a direct usage when each of the plurality of pieces of answer data is used and is, for example, an answer itself. The non-functional performance is a function indicating indirect evaluation from the direct function of each of the plurality of pieces of answer data and is, for example, a score. Alternatively, the non-functional performance in this case can be evaluation for the direct function of each of the plurality of pieces of answer data.

As another example, a model that generates a posted message or the like can be adopted. The functional performance in this case is content, the number of characters, or the like in the posted message, and the non-functional performance is the number of “likes” indicating empathy for the post, or the like.

Returning to FIG. 8, the training data generation unit 22 is a processing unit that generates training data, using each of the plurality of pieces of data stored in the corpus 13. For example, the training data generation unit 22 divides the data into the first portion and the second portion, generates training data using the first portion as an explanatory variable and the second portion as an objective variable (correct answer data), and stores the training data in the training data DB 14.

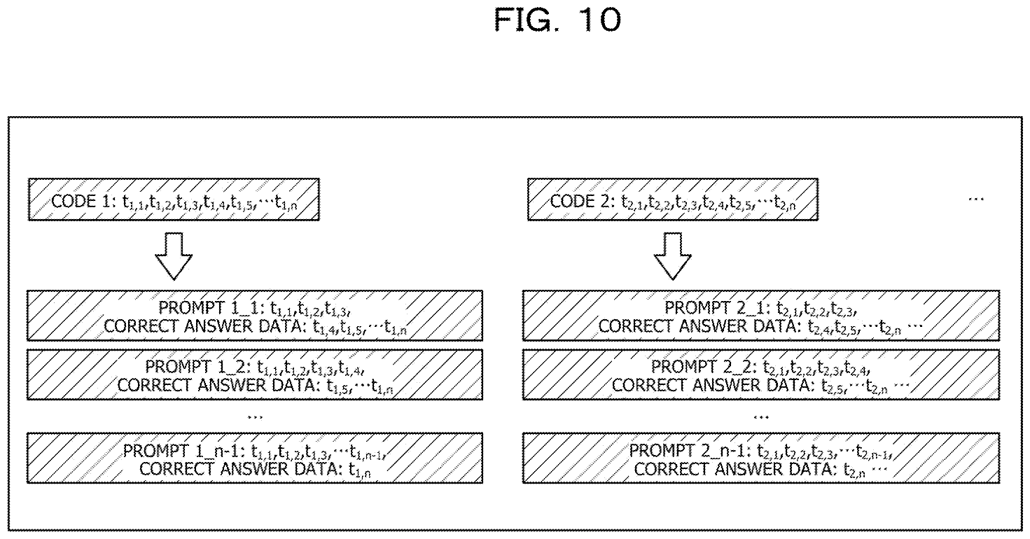

FIG. 10 is a diagram for explaining generation of the training data. As illustrated in FIG. 10, the training data generation unit 22 generates training data including a prompt 1_1 “t_{1,1}, t_{1,2}, t_{1,3}” and correct answer data “t_{1,4}, t_{1,5}, . . . , t_{1,n}” from a code 1 “t_{1,1}, t_{1,2}, t_{1,3}, t_{1,4}, t_{1,5}, . . . , t_{1,n}” of a program, including a plurality of sequences, stored in the corpus 13 and generates training data including a prompt 1_2 “t_{1,1}, t_{1,2}, t_{1,3}, t_{1,4}” and correct answer data “t_{1,5}, . . . , t_{1,n}”. In this way, the training data generation unit 22 generates training data including a prompt 1_n “t_{1,1}, t_{1,2}, t_{1,3}, . . . , t_{1,n-1}” and correct answer data “t_{1,n}” from the code 1.

Similarly, the training data generation unit 22 generates training data including a prompt 2_1 “t_{2,1}, t_{2,2}, t_{2,3}” and correct answer data “t_{2,4}, t_{2,5}, . . . , t_{2,n}” from a code 2 “t_{2,1}, t_{2,2}, t_{2,3}, t_{2,4}, t_{2,5}, . . . , t_{2,n}” of a program, including a plurality of sequences, stored in the corpus 13 and generates training data including a prompt 2_2 “t_{2,1}, t_{2,2}, t_{2,3}, t_{2,4}” and correct answer data “t_{2,5}, . . . , t_{2,n}”. In this way, the training data generation unit 22 generates training data including a prompt 2_n “t_{2,1}, t_{2,2}, t_{2,3}, . . . , t_{2,n-1}” and correct answer data “t_{2,n}” from the code 2.

As described above, since the training data generation unit 22 can generate the training data using the data stored in the corpus 13, it is possible to realize efficient generation of the training data and to generate accurate training data at high speed.

The machine learning unit 23 is a processing unit that trains the language model 15 that predicts the second portion of the data in response to the input of the first portion of the data, through machine learning using the divided data divided into the first portion of the plurality of pieces of data and the second portion of the plurality of pieces of data that is the correct answer data, as the training data. At this time, the machine learning unit 23 uses a loss function including a parameter that indicates a ratio of reflecting the non-performance function determined according to the measurement result of the non-performance function in the language model, as a loss function.

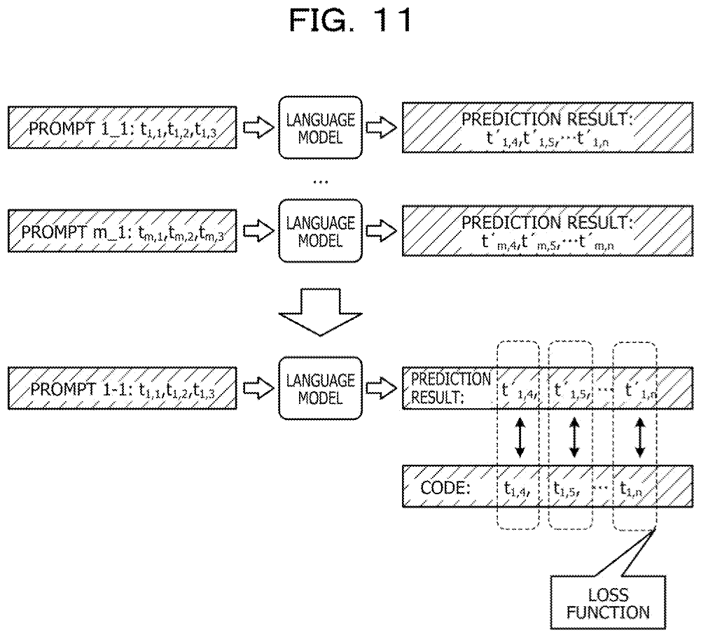

FIG. 11 is a diagram for explaining machine learning of the language model 15. As illustrated in FIG. 11, the machine learning unit 23 inputs the prompt 1_1 “t_{1,1}, t_{1,2}, t_{1,3}” into the language model 15 and acquires “t′_{1,4}, t′_{1,5}, . . . , t′_{1,n}” as a prediction result. Similarly, the machine learning unit 23 inputs the prompt 1_2 “t_{1,1}, t_{1,2}, t_{1,3}, t_{1,4},” into the language model 15 and acquires “t′_{1,5}, . . . , t′_{1,n}” as a prediction result.

In this way, the machine learning unit 23 acquires the prediction result by inputting a prompt m_1 “t_{m,1}, t_{m,2}, t_{m,3}” into the language model 15 and trains the language model 15 using the difference between the correct answer data and the prediction result. For example, the machine learning unit 23 trains the language model 15, using a difference between teacher data “prompt 1_1 (t_{1,1}, t_{1,2}, t_{1,3})+correct answer code (t_{1,4}, t_{1,5}, . . . , t_{1,n})” and a prediction result “prompt 1_1 (t_{1,1}, t_{1,2}, t_{1,3})+correct answer code (t′_{1,4}, t′_{1,5}, . . . , t′_{1,n})”.

At this time, the machine learning unit 23 trains the language model 15 using the difference between the correct answer data and the prediction result, by using a non-functional performance considered loss function illustrated in the formula (2).

[Expression 2]

loss=(λ*α+(1−λ))*loss_{diff} (2)

“λ×α” in the loss function of the formula (2) is a weight term corresponding to the parameter indicating the ratio of reflecting the non-performance function in the language model 15. “1−λ” is a loss term according to the difference between the correct answer data and the prediction result and a loss term based on the appearance probability of the superficial character of each of the plurality of pieces of data. The reference “loss_{diff}” is the cross entropy indicated in the formula (1). Furthermore, “α” is a measurement result of the non-functional performance and a value measured by the measurement unit 21. “λ” is an adjustment parameter indicating how much the non-functional performance is considered and can be arbitrarily set. For example, “λ” is a coefficient used to reflect superficial (character) differences considering that not all codes can be necessarily executed, and for example, in a case where λ is one, the functional performance is not reflected in the language model 15. In a case where the formula (2) is adopted as the loss function, a numerical value that decreases as the non-functional performance increases is used as “α”.

The prediction unit 24 is a processing unit that executes prediction processing, using the language model 15 generated by the machine learning unit 23. For example, the prediction unit 24 inputs a prompt of a program into the language model 15, acquires the prediction result of generating a code following the prompt, and can acquire a code of the program including the prompt and the code.

(Flow of Processing)

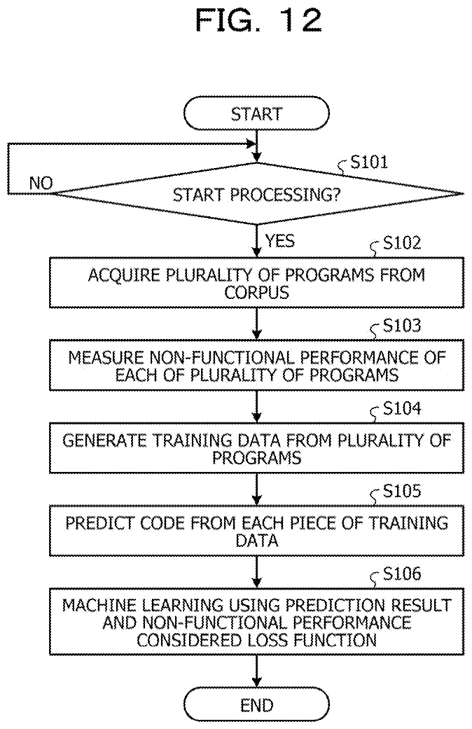

FIG. 12 is a flowchart illustrating a flow of processing according to the first embodiment. As illustrated in FIG. 12, when being instructed to start processing (S101: Yes), the measurement unit 21 acquires a plurality of programs from the corpus 13 (S102), and measures a non-functional performance of each of the plurality of programs (S103).

Subsequently, the training data generation unit 22 generates training data from the plurality of programs (S104). Then, the machine learning unit 23 predicts the code from the prompt using each piece of the training data (S105) and machine learns the language model 15, using the prediction result and the non-functional performance considered loss function (S106).

(Effects)

As described above, the information processing apparatus 10 collects and executes a large amount of scripts for creating a machine learning model and obtains prediction accuracy. The information processing apparatus 10 generates a pair of the prompt and the generated program from each program. For example, the information processing apparatus 10 determines the shortest prompt length in advance and generates a pair of the prompt and data to be generated of which a length is longer than the shortest prompt length.

The information processing apparatus 10 generates the program from each prompt using the language model 15, calculates a non-functional performance type cross entropy loss using the prediction result and the correct answer data, and reflects the cross entropy loss in the language model 15. In this way, the information processing apparatus 10 adds a term according to accuracy evaluation to a loss function at the time of machine learning of the language model 15 so as to generate a highly non-functional program that can be executed. Therefore, the information processing apparatus 10 can generate the prediction result that satisfies the required non-functional performance in a short time.

Furthermore, by performing machine learning considering characteristics required for the program, the information processing apparatus 10 can generate the program that can be executed and has a high non-functional performance such as an execution speed or prediction accuracy, and software can be developed without repeating generation and trial.

Furthermore, the information processing apparatus 10 can perform machine learning with the loss function using only the weight term “λ×α” corresponding to the parameter indicating the ratio of reflecting the non-performance function in the language model 15, without using the “1−λ” term. As a result, the information processing apparatus 10 can easily generate the language model 15 specialized for the non-performance function.

Furthermore, since the information processing apparatus 10 can arbitrarily set the value of “λ” in the formula (2), which one of the functional performance and the non-performance function is emphasized can be dynamically changed according to a model application destination or the like. Therefore, a training method according to a use of the model can be provided.

Furthermore, since the information processing apparatus 10 can perform machine learning not only on the programs but also document data or the like, the information processing apparatus 10 can realize a machine learning method with high versatility.

### Second Embodiment

Incidentally, while the embodiment of the present disclosure has been described above, the present disclosure may be implemented in a variety of different modes in addition to the embodiment described above.

(Numerical Values, Etc.)

The program examples, the training data examples, or the like used in the embodiment described above are merely examples, and may be freely modified. Furthermore, the processing flow described in each flowchart may be appropriately modified in a range without contradiction.

(System)

Pieces of information including the processing procedure, control procedure, specific name, various types of data and parameters described above or illustrated in the drawings may be optionally modified unless otherwise noted.

Furthermore, the respective components of the respective devices illustrated in the drawings are functionally conceptual, and do not necessarily need to be physically configured as illustrated in the drawings. For example, specific forms of distribution and integration of each of the devices are not limited to those illustrated in the drawings. For example, all or a part of the devices may be configured by being functionally or physically distributed or integrated in optional units according to various loads, use situations, or the like. For example, the measurement unit 21, the training data generation unit 22, the machine learning unit 23, and the prediction unit 24 can be implemented by different computers (housings).

Moreover, all or any part of each processing function performed in each device may be implemented by a central processing unit (CPU) and a program analyzed and executed by the CPU, or may be implemented as hardware by wired logic.

(Hardware)

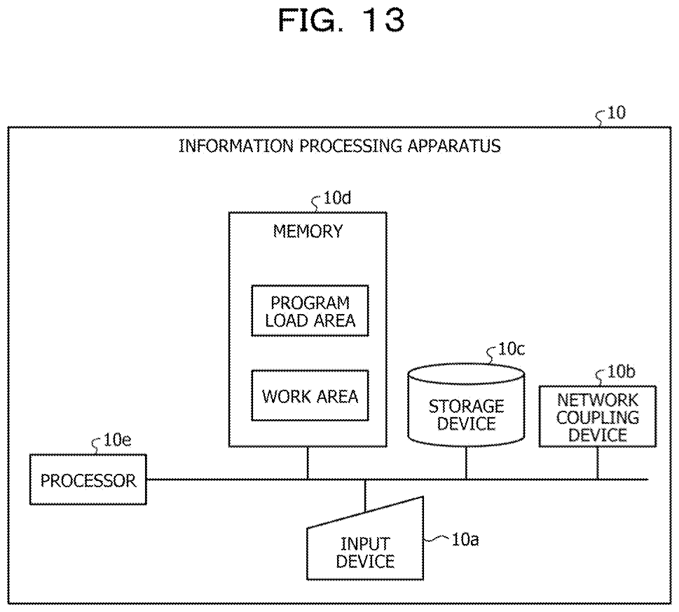

FIG. 13 is a diagram illustrating a hardware configuration example. As illustrated in FIG. 13, the information processing apparatus 10 includes an input device 10a, a network coupling device 10b, a storage device 10c, a memory 10d, and a processor 10e. Furthermore, each of the units illustrated in FIG. 13 is mutually coupled by a bus or the like.

The input device 10a is a mouse, a keyboard, or the like and receives inputs of various types of information. The network coupling device 10b is a network interface card or the like and communicates with another device. The storage device 10c stores programs that operate the functions illustrated in FIG. 8 and DBs.

The memory 10d includes a program load area and a work area. The processor 10e reads a program that executes processing similar to that of each processing unit illustrated in FIG. 8 from the storage device 10c or the like, and develops the read program in the memory 10d, so as to operate a process that executes each function described with reference to FIG. 8 or the like. For example, this process executes a function similar to that of each processing unit included in the information processing apparatus 10. For example, the processor 10e reads a program having similar functions to the measurement unit 21, the training data generation unit 22, the machine learning unit 23, the prediction unit 24, or the like from the storage device 10c or the like. Then, the processor 10e executes a process of executing processing similar to the measurement unit 21, the training data generation unit 22, the machine learning unit 23, the prediction unit 24, or the like.

In this manner, the information processing apparatus 10 works as an information processing apparatus that executes an information processing method by reading and executing a program. Furthermore, the information processing apparatus 10 may implement functions similar to the functions in the embodiments described above by reading the program described above from a recording medium with a medium reading device and executing the read program described above. Note that the program referred to in other embodiments is not limited to being executed by the information processing apparatus 10. For example, the embodiments described above may be similarly applied also to a case where another computer or server executes the program or a case where these computer and server cooperatively execute the program.

This program may be distributed via a network such as the Internet. Furthermore, this program may be recorded in a computer-readable recording medium such as a hard disk, a flexible disk (FD), a compact disc read only memory (CD-ROM), a magneto-optical disk (MO), or a digital versatile disc (DVD) and may be executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning program for causing a computer to execute processing comprising:
measuring, for each of a plurality of pieces of data, a non-functional performance that represents a performance for a requirement that excludes a function of each of the plurality of pieces of data; and
by machine learning that uses divided data obtained by dividing each of the plurality of pieces of data into a first portion of the data and a second portion that is correct answer data as training data, executing machine learning processing of training a prediction model that predicts the second portion of the data in response to an input of the first portion of the data, wherein
the machine learning processing uses a loss function that includes a parameter determined according to a measurement result of the non-functional performance that is the parameter that indicates a ratio of reflecting the non-functional performance in the prediction model.

2. The non-transitory computer-readable recording medium according to claim 1, wherein
as the loss function for the machine learning processing, the loss function that includes a weight term to which the parameter is set and a loss term according to a difference between the correct answer data and a prediction result is used.

3. The non-transitory computer-readable recording medium according to claim 2, wherein
as the loss term of the loss function for the machine learning processing, the loss term based on an appearance probability of a superficial character of each of the plurality of pieces of data is used.

4. The non-transitory computer-readable recording medium according to claim 2, wherein
the measuring
measures, for each of a plurality of programs, the non-functional performance that excludes a function that defines an operation of each of the plurality of programs, and
the executing the machine learning processing
executes, through machine learning that uses divided data obtained by dividing each of the plurality of programs into a head portion and a subsequent portion that is correct answer data as training data, machine learning processing of training the prediction model that predicts the subsequent portion of the program according to an input of the head portion of the program.

5. The non-transitory computer-readable recording medium according to claim 2, wherein
the measuring
measures, for each of a plurality of pieces of document data, the non-functional performance that indicates evaluation for an indirect function from a direct function of each of the plurality of pieces of document data, that excludes a function that defines a direct usage when each of the plurality of pieces of document data is used, and
the executing the machine learning processing
executes, through machine learning that uses divided data obtained by dividing each of the plurality of pieces of document data into the first portion and the second portion that is correct answer data as training data, machine learning processing of training the prediction model that predicts the second portion according to an input of the first portion of the document data.

6. A machine learning method comprising:
measuring, for each of a plurality of pieces of data, a non-functional performance that represents a performance for a requirement that excludes a function of each of the plurality of pieces of data; and
by machine learning that uses divided data obtained by dividing each of the plurality of pieces of data into a first portion of the data and a second portion that is correct answer data as training data, executing machine learning processing of training a prediction model that predicts the second portion of the data in response to an input of the first portion of the data, wherein
the machine learning processing uses a loss function that includes a parameter determined according to a measurement result of the non-functional performance that is the parameter that indicates a ratio of reflecting the non-functional performance in the prediction model.

7. An information processing apparatus comprising:
a memory; and
a processor coupled to the memory and configured to:
measure, for each of a plurality of pieces of data, a non-functional performance that represents a performance for a requirement that excludes a function of each of the plurality of pieces of data; and
by machine learning that uses divided data obtained by dividing each of the plurality of pieces of data into a first portion of the data and a second portion that is correct answer data as training data, execute machine learning processing of training a prediction model that predicts the second portion of the data in response to an input of the first portion of the data, wherein
the machine learning processing uses a loss function that includes a parameter determined according to a measurement result of the non-functional performance that is the parameter that indicates a ratio of reflecting the non-functional performance in the prediction model.
